(19) United States
(12) Patent Application Publication
(10) Pub. No.: US 2003/0177012 A1
(43) Pub. Date: Sep. 18, 2003

(54) Voice activated thermostat

(76) Inventor: Brett Drennan, Hobbs, NM (US)

Correspondence Address: HOWREY SIMON ARNOLD & WHITE LLP, 1299 PENNSYLVANIA AVE., NW, BOX 34, WASHINGTON, DC, 20004, US

(21) Appl. No.: 10/063,029

(22) Filed: Mar. 13, 2002

(51) Int. Cl. G10L 21/00

(52) U.S. Cl. 704/275

(57) ABSTRACT

A thermostat according to the present invention is capable of capturing audio commands from a user for controlling HVAC systems. The thermostat can operate in training mode and control mode. In training mode, the user can tailor a list of predefined keywords with his voice and, in control mode, the user can change HVAC system settings. Optionally, the thermostat is equipped to interface with a remote unit. The user can speak audio commands into the remote unit, and the remote unit will transmit his commands to the thermostat.

### BACKGROUND OF INVENTION

1. Technical Field

The present invention relates to apparatus for controlling heating and air conditioning equipment and particularly to the control apparatus that employs computers with voice recognition capabilities.

2. Background Information

Heating, ventilation, and air conditioning (HVAC) systems have become important systems to provide comfort nowadays, and it has almost become a staple item in any home or work place. For example, through the use of an HVAC system, one can have a temperature of 70 degrees Fahrenheit in his house while the outside temperature is either sub zero or 90 degrees Fahrenheit.

HVAC system can be adjusted through a control system, also known as a thermostat, to provide an ideal temperature setting for an environment. Advanced thermostats even automatically changes temperature setting according to predefined instructions. By way of example, a homeowner can program a thermostat to have 70 F. degrees when he wakes up in the morning, 55 F. degrees when the house is empty after he leaves for work, 70 F. degrees when he returns from work, and 60 F. degrees when he goes to sleep. These advanced thermostats provide comfort and at the same time saves energy.

However, most of the advanced thermostats are designed to make life easier for people without any physical deficiency and not for visually impaired people. For visually impaired people, it is impossible to use these advanced thermostats because they cannot read the display or enter the instructions. Visually impaired people have to rely on others to properly set the thermostat for them.

Senior citizens also have difficulties using these advanced or programmable thermostats. Senior citizens often have difficulties reading long instructions, which often are written in small fonts and in quasi-technical language, and follow them accordingly. They also have to rely on other people to properly program these advanced thermostats.

Difficulty to read the instructions is not confined to senior citizens. Because often the thermostats are located in hallways or places not well illuminated, the reading of the display screen can be a problem even for the general population.

Another situation where the traditional thermostat does not provide necessary function is when the HVAC system is used in a place where many people gather and the thermostat is accessible by many people. It is not uncommon that a comfortable setting for one person is either too hot or too cold for another person, and consequently people tend to change the setting in search of an optimal temperature. In order to prevent an person, often unauthorized, to change the temperature setting, the thermostats are usually enclosed in a transparent plastic lockbox. The lockbox does not stop people from attempting to use clips, wires, etc. to change the temperature setting, and the lockbox can be a problem if the key is ever lost.

### SUMMARY OF INVENTION

Briefly described, the present invention is a voice activated and remotely controlled thermostat for use with ordinary HVAC systems. In one embodiment of the present invention, a thermostat is equipped with an audio input unit, which has a microphone and can capture and process a user's oral instructions into commands to an ordinary HVAC control unit. The thermostat according to the present invention is also equipped with an audio output unit, where audio prompts are played to the user, besides the common keyboard input unit and the display output unit.

The thermostat operates in two modes: a control mode and a training mode. The control mode allows a user to orally instruct the thermostat to adjust the temperature. The user can speak to the thermostat and ask the heater or the air conditioner to be turned on or turned off. The user can also set a specific temperature in either heating mode or cooling mode. The user can say, for example, “heat at 75 degrees” and the thermostat will interpret this as a command to turn on the heater and set the temperature to 75 degrees. The user can also say “heat at 80 degrees,” which also tells the thermostat to turn on the heater and set the temperature to 80 degrees. If the user wants to turn on the fan, he would say, “fan on,” and the thermostat will set the fan to “on” instead of “auto” or “off” as the case may be. The thermostat can be optionally programmed to understand other languages, such as French, Spanish, German or Japanese.

In the training mode, the thermostat is capable of memorizing specific command words pronounced by the voice of a user, and the user can also set a control keyword, which can be used to enter the control mode. After the control keyword is set, the thermostat enters the control mode only after the control keyword is spoken. The control keyword prevents the thermostat from changing its setting inadvertently by spoken words and also prevents unauthorized persons from changing the temperature setting.

The training mode is also ideal for the thermostat to memorize user's pronunciation. If the user speaks certain words in a specific way, the thermostat will remember them and interpret them correctly.

The audio output unit of the thermostat according to the present invention is also equipped with a speaker, which can play audio prompts or provide responses to a user's commands. The speaker can play the command prompts for visually impaired users and can also play responses to a user's commands. For example, the user can ask, “what is the current setting?” Then, the speaker will output the current thermostat setting, for example, “75 degrees. Fan setting in the on position.” In an alternate embodiment, the thermostat may have a transceiver input unit and a corresponding remote unit. The user can speak in a normal voice into the remote unit his commands for setting the thermostat, and the remote unit will transmit his commands to the thermostat. The remote unit is very useful when the user is in a large room and removed from the thermostat and makes it unnecessary for the user to walk to the thermostat or to other wise speak in something besides a normal voice.

### BRIEF DESCRIPTION OF DRAWINGS

The foregoing and other aspects and advantages of the invention described herein will be better understood from the following detailed description of one or more preferred embodiments of the invention with reference to the drawings in which:

FIG. 1 is an illustration of one embodiment of the present invention.

FIG. 2 is an illustration of an alternate embodiment of the present invention.

FIG. 3 is a block diagram of a thermostat.

FIG. 4 is a block diagram of a remote unit.

FIG. 5 is a flow chart for the thermostat.

FIG. 6 is a flow chart for the training mode.

FIG. 7 is a flow chart for the control mode.

### DETAILED DESCRIPTION

As required, detailed embodiments of the present invention are disclosed herein. However, it is to be understood that the disclosed embodiments are merely exemplary of the invention(s) that may be embodied in various and alternative forms. The figures are not necessarily to scale; some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

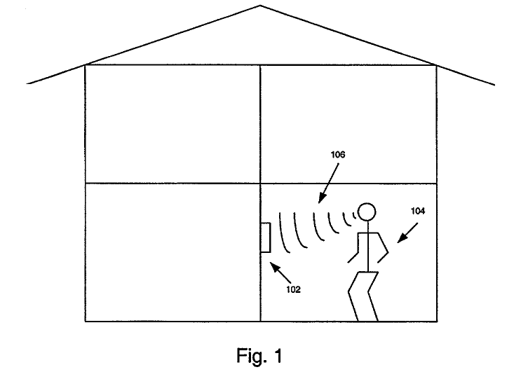

Referring now in greater detail to the drawings, in which like numerals represent like components throughout several views, FIG. 1 depicts use of a thermostat 100 according to the present invention. The thermostat 102 has a appearance generally similar to other thermostats and is also wall mounted. A user 104 in the room can instruct the thermostat to change its setting through audio commands. The commands travel from the user 104 to the thermostat 102 through audio waves 106, and thus eliminate the need for the user 104 to be near the thermostat 102. The distance between the user 104 and the thermostat 102 depends on the user's voice volume and the sensitivity of the thermostat's microphone. For more sensitive microphones, the user 104 may give commands farther away from the thermostat 102 or even in a different room. However, more sensitive microphones may capture more undesirable noises and demand better quality audio processing circuitry.

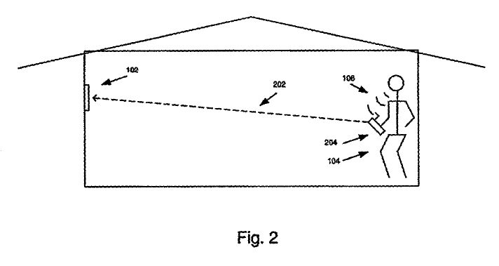

FIG. 2 illustrates use of a remote unit 200 according to an alternate embodiment of the present invention. In a large room setting, such in a gym, a hall, or a large office, the remote unit 204 permits the user 106, who may be farther away from the thermostat 102, to conveniently change the thermostat 102 setting by speaking the commands into the remote unit 204, which then transmits the commands via radio signals or infrared signals 202 to the thermostat 102. If the commands are transmitted through radio signals, there is no need for line of sight between the remote unit 204 and the thermostat 102. If the transmission is through infrared signals, then there can be obstacle between the remote unit 204 and the thermostat 102.

The remote unit 204 is also helpful in the situation where there are many people in the room and it is inconvenient for the user 106 to command the thermostat 102 in a loud voice. The user 106 can simply speak in his normal voice into the remote unit 204 and let the remote unit 204 transmit his commands to the thermostat 102.

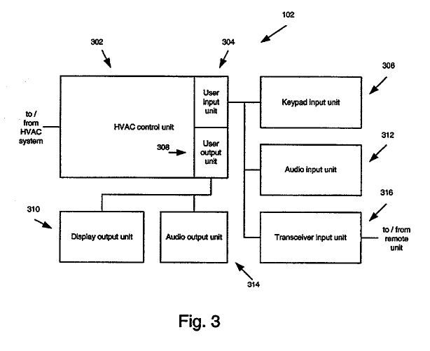

FIG. 3 depicts a block diagram of a thermostat 102 according to the present invention, The thermostat 102 has a HVAC control unit 302, which interfaces with HVAC equipment ( e.g., heater and air conditioner), a user input unit 304 that takes control inputs from a keypad input unit 304, an audio input unit 312, and a transceiver input unit 316. The transceiver input unit 316 is optional and interfaces with the remote unit 204.

The thermostat 102 has also a user output unit 308 that interfaces with a display output unit 310 and an audio output unit 314. The display output unit 310 displays messages to the user, and the audio output unit 314 plays the corresponding messages to a speaker (not shown) built into the thermostat 102.

The keypad input unit 306 is similar to keypads generally available in programmable thermostats. The keypad may include buttons for increasing or decreasing the temperature setting, for selecting heating or cooling modes, as well as for other control functions. The user 106 can change the thermostat 102 setting by using the keypad like the traditional programmable thermostats.

The audio input unit 312 is responsible for capturing, user's audio commands. It has an embedded microphone, an audio processing unit, and a store unit for storing audio command signals. The audio input unit 312 captures an audio command, processes it, and compares it with the stored commands to determine the desired actions. The audio input unit is also responsible for storing and identifying control keywords. The audio input unit 312 also stores the control keywords provided by the user in NVRAM (non volatile random access memory). The audio processing unit, also known as the voice recognition unit, is formed by a plurality of band pass filters, a multiplexer and an A/D converter as is well known. An audio signal is filtered by the band pass filters and in turn is supplied to the A/D converter through the multiplexer. The A/D converter converts the audio signal into a digital signal, which is compared with stored commands to recognize the audio command given by the user.

The transceiver input unit 316 may be included in one alternate embodiment, and it is responsible for communicating with a remote unit 204. The communication between the transceiver input unit 316 and the remote unit 204 can be through either radio signals or infrared signals. The commands received by the transceiver input unit 316 are sent to the user input unit 304 for execution.

The audio output unit 314 is responsible for playing audio messages to users. Audio messages may be generated in several methods presently known in the art and one such method is by feeding a digital signal into a voice synthesizer. The audio output unit 312 receives information in digital format and uses a voice synthesizer to convert the digital format into audible sound that is played over a speaker.

The display output unit 310 is similar to a display unit available in programmable thermostats. The display output unit 310 gets information from the user output unit 308 and displays it on a liquid crystal display (LCD) screen or other output screen of suitable means.

The user input unit 304 controls and interfaces input devices. It receives commands from the keypad input unit 306, the audio input unit 312, or the transceiver input unit 316. The user input unit 304 takes the commands and feed them to the HVAC control unit 302.

The user output unit 308 controls and interfaces output devices besides interfacing with the user input unit 304. The user output unit 308 sends information to both the display output unit 310 and the audio output unit 314.

The HVAC control unit 302 receives commands from the user input unit 304 and reports the status to the user output unit 308. The HVAC control unit 302 also sends control signals to the HVAC equipment.

In an alternative embodiment, the functions described above may be redistributed in different modules. The user input unit 304 and the user output unit 308 may be combined with some control logic from the audio input unit 312 to form a control unit that is responsible for overseeing the audio input and audio output operations.

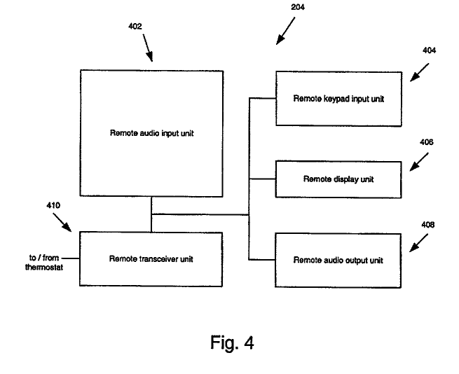

FIG. 4 is a block diagram for the remote unit 204. The remote unit 204 is a hand-held device that allows a user to enter his commands remotely without speaking in a loud voice towards the thermostat 102. The remote unit 204 is an optional device and if it is used, the thermostat 102 must be equipped with a transceiver input unit 316 or other similar unit capable of exchanging information with the remote unit 204.

The remote unit 204 has a remote audio input unit 402, a remote keypad input unit 404, a remote display unit 406, a remote audio output unit 408, and a remote transceiver unit 410. The user 104 can speak his commands for setting the thermostat 102 in a normal voice into the remote unit 204, and the remote audio input unit 402 captures the commands. The remote audio input unit 402 has similar capabilities as the audio input unit 312 in the thermostat 102. It also has an embedded microphone, an audio processing unit, and a store unit for storing audio command signals. The remote audio input unit 402 captures audio commands, processes them, and compares them with the stored commands to determine the desire actions. The remote audio input unit 402 also stores control keywords received from the thermostat 102 in NVRAM (non-volatile random access memory). The thermostat 102 is responsible for synchronizing the control keywords stored in the thermostat 102 and in the remote unit 204. The audio processing unit is formed by a plurality of band pass filters, a multiplexer and an A/D converter as is well known. An audio signal is filtered by the band pass filters and in turn is supplied to the A/D converter through the multiplexer. The A/D converter converts the audio signal into a digital signal, which is compared with stored commands to recognize the audio commands given by the user.

The remote keypad input unit 404 is also similar to the keypad input unit 306 in the thermostat 102. The user may have full control of the thermostat 102 by using the remote keypad input unit 404.

The remote display unit 406 may have a smaller display screen compared to the display screen of the thermostat 102, and may display messages identical or similar to those displayed by the thermostat 102. The remote display unit 406 receives information from the thermostat 102 and displays it on the remote unit 204.

The remote audio output unit 408 is similar to the audio output unit 314 in the thermostat 102. Audio messages may be generated in several methods presently known in the art and one such method is by feeding a digital signal into a voice synthesizer. The remote audio output unit 408 receives information in digital format from the thermostat 102 and uses a voice synthesizer to convert the digital format into audible sound that is played over a speaker.

The remote transceiver unit 410 is responsible for communication between the remote unit 204 and the thermostat 102. The remote transceiver unit 410 sends and receives information from the transceiver input unit 316 in the thermostat 102. The communication is preferably done via radio signals. Alternatively, the communication may also be accomplished via infrared signals.

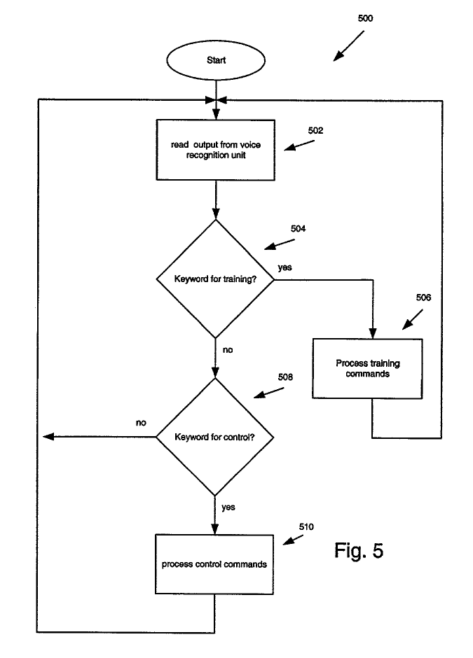

FIG. 5 is a simplified flow chart 500 for the operations of a thermostat according to the present invention. The thermostat 102 constantly reads output from the voice recognition unit (audio processing unit), block 502, and checks for keywords. If the output is a keyword related to training, block 504, then a routine for processing training commands is invoked, block 506. After processing the training routine, the thermostat 102 returns to monitoring the outputs from the voice recognition unit. If the output is a keyword related to control, block 508, then a routine for processing control commands is invoked, block 510, and the thermostat 102 returns to monitoring the output afterwards. If the output is neither a training keyword nor a control keyword, then it is discarded and the thermostat 102 returns to monitoring the output.

The user can determine the keywords for control and training. For example, the user may use “weather” as the control keyword and “learn” as the training keyword. The thermostat 102 will execute the specified routine once the user speaks the corresponding keyword.

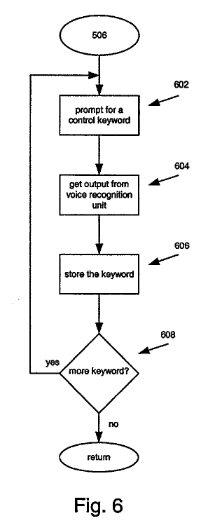

FIG. 6 is a flow chart for the training process 506. The thermostat 102 can be “trained” to a specific user's voice by having the user speaking in a normal voice the control keywords. Preferably there is a list of predefined keywords used by the thermostat, and these keywords may include heat, cool, increase, decrease, fan, on, auto, etc. The user is prompted for each keyword in the list, block 602, and the thermostat 102 will capture user's pronunciation of such keywords. The user's spoken words are processed by the voice recognition unit, block 604, and stored, block 606, as a reference for future use. If there are more keywords to be “memorized,” block 608, blocks 602-6 will be repeated.

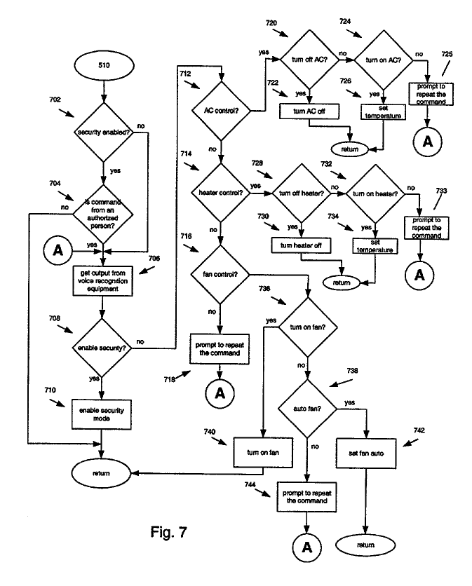

FIG. 7 is a simplified flow chart of the control mode 510. After a control keyword is detected by the thermostat 102, the thermostat 102 checks whether the security feature is enabled, block 702.

The security feature, when enabled, prevents unauthorized people from giving audio commands to change the thermostat settings. The security feature is especially useful in large offices, where many people are located, because it prevents the thermostat 102 setting from being changed by unauthorized persons. The security feature also eliminates the need to enclose the thermostat 102 in a lockbox.

If the security feature is enabled, the thermostat 102 checks whether the keyword is given by an authorized person, block 704, by comparing the digital signal of the keyword with the keyword pronounced by the authorized person and stored in the memory. If the keyword is not from the authorized person, then the thermostat 102 does not continue with the control mode and returns to monitoring the output from the voice recognition unit.

If the security feature is not enabled, or if the security feature is enabled and the keyword is from the authorized person, the thermostat 102 gets additional output from the voice recognition unit, block 706. If the additional output is a command for enabling the security feature, block 708, then the security mode is set or enabled, block 710.

If the additional output is not for enabling the security mode, then additional checks are done for air conditioning control, block 712, heater control, block 714, and fan control, block 716.

If the additional output is for air conditioning control, it is checked if the output is to turn off the air conditioning equipment, block 720. If it is for turning off the air conditioner, the thermostat 102 turns the air conditioner off, block 722. If the output is to turn on the air conditioner or to set the temperature at a certain degree, the thermostat 102 turns on the air conditioner and sets the temperature to the desired level, block 726. If the thermostat fails to recognize the output, it prompts the user to repeat the command 725 and goes back for additional inputs.

If the additional output is for heater control, it is checked if the output is to turn off the heating equipment, block 728. If it is for turning off the heater, the thermostat 102 turns the heater off, block 730. If the output is to turn on the heater or to set the temperature at a certain degree, the thermostat 102 turns on the heater and sets the temperature to the desired level, block 734. If the thermostat fails to recognize the output, it prompts the user to repeat the command 733 and goes back for additional inputs.

If the additional output is for fan control, it is checked if the output is to turn on the fan, block 736. If it is for turning on the fan, the thermostat 102 turns the fan on, block 740. If the output is to set the fan to the auto mode, the thermostat 102 sets the fan to the auto mode, block 742. If the thermostat fails to recognize the output, it prompts the user to repeat the command 744 and goes back for additional inputs.

If the additional output is not a recognizable command, then the thermostat 102 prompts the user to repeat the command 718 and goes back for additional inputs.

The sequence of command checking illustrated in FIG. 7 is for illustration purpose and people skilled in the art will appreciate alternate sequences.

In operation, the thermostat 102 according to the present invention enables easy control of temperatures by people who are visually impaired. If a user wants to lower the temperature setting in the summer time, he can say, air conditioner at 75 degrees. The audio input unit 312 of the thermostat 102 captures the user's audio command and processes it. The command, “air conditioner at 75 degrees” is converted to digital signals and compared with a list of stored words and commands. The thermostat 102 checks the command and detects it as a control command, not as a training command, and invokes a command routine to process this command. The command routine interprets the command as a command for air conditioner control and sets the temperature to 75 degrees.

The thermostat 102 is preferably loaded with a list of predefined commands initially, and the user can customize these predefined commands with his voice. The user can invoke the training mode by pronouncing a predefined control keyword, and the thermostat 102 interprets it, as the user wants to overwrite the list of predefined commands with his voice. The thermostat 102 then prompts through the audio output unit 314 for the user to record his version of keywords. The keywords are captured by the audio input unit 312 and stored in the memory.

In an alternative embodiment, the thermostat according to the present invention is equipped with a remote unit 204, from which a user can enter his audio commands. If the user is a large room and away from the thermostat 102, the user can speak the audio commands in a normal voice into the remote unit 204. The remote audio input unit 402 captures the audio commands and transmits them through the remote transceiver unit 410 and the transceiver input unit 316 to the thermostat 102. The audio commands can be transmitted via infrared signals, radio signals, or other suitable transmission means.

In yet another embodiment, the remote unit 204 may be stripped of most of its intelligence. The remote unit 204 can be a simple wireless microphone and a speaker, and all audio processing functions are done by the thermostat 102. In this embodiment, the remote unit 204 captures user's audio commands and transmits them to the thermostat 102. The transceiver input unit 316 of the thermostat receives the commands and sends them to the audio input unit 312 for processing. The audio prompts are transmitted by the transceiver input unit 316 to the remote unit 204, where they are played by the speaker.

The present invention is equally applicable to programmable thermostats, also known as auto set back thermostats. The thermostat according to the present invention can be provisioned to prompt a user for programming instructions, such as setting the date and time, setting one temperature for one specific time period, and setting another temperature for another time period.

The foregoing description of preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical applications to enable others skilled in the art to utilize the invention and various embodiments and with various modifications as are suited to the particular use contemplated.

1. A voice activated thermostat for controlling heating, ventilation, and air conditioning equipment, the system comprising:
a control unit;
an audio input unit;
an audio output unit; and
a transceiver input unit for communicating with a remote unit,
wherein the audio input unit is capable of capturing audio commands from a user and converting the audio commands into digital signals

2. The system of claim 1 further comprising
a remote unit having
a remote audio input unit, and
a remote transceiver unit,
wherein the remote transceiver unit of the remote unit communicates with the transceiver input unit of the thermostat.

3. The system of claim 1, wherein the audio input unit of the thermostat is equipped to receive security keywords.

4. The system of claim 2, wherein the remote audio input unit of the remote unit is capable of capturing audio commands from a user and converting the audio commands into digital signals.

5. The system of claim 1, wherein the thermostat has a list of predefined commands.

6. The system of claim 1, wherein the thermostat further comprises a keypad input unit and a display output unit.

7. The system of claim 2, wherein the remote unit further comprises a remote audio output unit.

8. The system of claim 2, wherein the remote unit further comprises a remote keypad input unit and a remote display unit.

9. A method for controlling an HVAC system by using audio commands, the method comprising:
providing a voice activated thermostat; and
speaking an audio command for controlling the HVAC system to the thermostat.

10. The method of claim 9 further comprising speaking a keyword to the thermostat.

11. The method of claim 9 further comprising recording the keyword.

12. The method of claim 9 further comprising recording a list of predefined audio commands.

13. A method for controlling a HVAC system by using audio commands, the method comprising:
providing a voice activated thermostat;
providing a remote unit; and
speaking an audio command for controlling the HVAC system to the remote unit.

14. The method of claim 13 further comprising speaking a keyword to the remote unit.

15. The method of claim 13 further comprising recording a keyword.

16. The method of claim 13 further comprising recording a list of predefined audio commands.

17. A method for controlling a HVAC system by speaking audio commands to a voice activated thermostat, the method comprising:
receiving a control keyword;
verifying the control keyword is from an authorized user;
processing an audio command, if the control keyword is from an authorized user; and
ignoring the audio command, if the control keyword is not from an authorized user.

18. The method of claim 17, wherein the step of processing audio commands further comprises:
comparing the audio command with a list of predefined audio commands;
executing HVAC control commands, if the audio command matches one of the predefined audio commands; and
discarding the audio command, if the audio command does not match any of the predefined commands.

19. The method of claim 17 further comprising recording a list of predefined commands.

20. A method for controlling a HVAC system by speaking audio commands to a remote unit, which is in communication with a voice activated thermostat, the method comprising:
receiving a control keyword;
verifying the control keyword is from an authorized user;
processing an audio command, if the control keyword is from an authorized user;
ignoring the audio command, if the control keyword is not from an authorized user; and
transmitting the audio command to the thermostat.

21. The method of claim 20, wherein the step of processing audio commands further comprises:
comparing the audio command with a list of predefined commands;
executing HVAC control commands, if the audio command matches one of the predefined audio commands; and
discarding the audio command, if the audio command does not match any of the predefined commands.

22. The method of claim 20 further comprising recording a list of the predefined commands.
